(19) United States
(12) Patent Application Publication
(10) Pub. No.: US 2013/0127791 A1
(43) Pub. Date: May 23, 2013

(54) Thumb or Finger Devices with Electrically Conductive Tips & Other Features for Use with Capacitive Touch Screens and/or Mechanical Keyboards Employed in Smartphones & Other Small Mobile Devices

(71) Applicant: Raymond Albert Siuta, Corvallis, OR (US)

(72) Inventor: Raymond Albert Siuta, Corvallis, OR (US)

(21) Appl. No.: 13/300,520

(22) Filed: Nov. 18, 2011

(51) Int. Cl. G06F 3/033

(52) U.S. Cl. 345/179

(57) ABSTRACT

A pair of thumb or finger sleeves incorporating electrically conductive tips operates as passive styluses that enable accurate user engagement with capacitive touch displays. Capacitive touch screens are commonly found on smartphones and other handheld devices. Capacitive touch screens are normally activated by direct thumb or finger touch. The human thumb or finger, however, provides a contact area that is too large to allow precise character selection on the small keys found on these devices. The present invention satisfies the electrical conductivity requirements for capacitive touch screens and, through its small contact point, reduces the excessive contact area of the thumb or finger. This invention also maintains or improves upon other operating characteristics of the thumb or finger when interacting with capacitive touch screens and small mechanical keyboards.

### FIELD OF THE INVENTION

The present invention relates to input devices, such as thumb & finger caps and pen-like styluses, which have the objective of improving the user experience with small capacitive touch screens. Capacitive display technology is commonly found in smartphones & other handheld devices. The term “smartphone” is defined as those cell phones with character & number set keyboards that include, but are not limited to, QWERTY, Dvorak, foreign language alphabets and character sets, note pads and number pads. These keyboards are suitable for text messaging, instant messaging, e-mailing and Internet connection capabilities. As used herein, the term “smartphone” can include those with full capacitive touch screen displays and those that combine small mechanical keyboards with full or partial screens of any touch display technology.

The invention described herein pertains to thumb and/or finger sleeves with passive electrically conductive tips that improve the user's ability to enter text messages, instant messages, e-mails, and other information using the small keyboards on smartphones as defined above or on other handheld devices.

### THE PRIOR ART

Since the development of early handheld computers, PDA's and other highly mobile devices, numerous inventions have been set forth with the intention of improving a user's ability to interface with these ever smaller yet more capable devices. Manufacturers of smartphones and other hand-held devices have long recognized that the user's ability to interface effectively with their products is a key limiting factor in achieving full use of the devices' capabilities. In turn, handheld device manufacturers frequently provide pen-like styluses with their original products to improve upon the user's ability to input text & data in the ever smaller yet more powerful devices. Individual inventors have also responded to this growing need by developing new pen-like styluses and/or thumb/finger devices with small tips that provide smaller contact areas with the device screens.

A review of the prior art suggests that the extant pertinent inventions can be categorized according to their design relevance to the present invention and to the performance issues that they are addressing. The prior art relevant to the present invention that arises from our patent search can be grouped into five categories. These categories and the related prior art are described in the following paragraphs.

The first category, which represents a sizable portion of the relevant prior art, applies to finger tip or pen-like styluses that are designed to improve a user's ability to interact with non-conductive (i.e., non capacitive touch screens) displays. Adjustable finger styluses can be found in U.S. Pat. No. 6,533,480 (Adjustable Finger Stylus), U.S. Pat. No. 6,626,598 B2 (Adjustable Finger Stylus), U.S. Pat. No. 6,075,189 (Artificial Finger Tip) and U.S. 2010/0188326 A1 (Ornamental Thumb or Finger Ring with Secured Hidden Contact Interface Input. Non-adjustable finger tip styluses are set forth in U.S. Pat. No. D 487,896 S (Finger Tip Stylus for Small Keyboards & Touch-Screen Data Input) and U.S. 2005/0093835 (Finger Tip Stylus for Handheld Computing Devices). Other prior art specifically U.S. Pat. No. 5,461,204 (Segmented-core Inductance in Stylus for EM-graphical tablet) addresses pressure sensitive display devices. Notably, all these variations are not compatible with and do not activate capacitive touch displays.

A second major category of the prior art applies to ergonomic issues relevant to a user's ability to select characters or enter data under different circumstances. U.S. Pat. No. 6,587,090 B1 (Finger Securable Computer Input Device) and U.S. Pat. No. 6,905,271 B1 (Finger Mounted Marking Device) are directed exclusively toward ergonomic issues by precluding the user from having to grasp a pen-like device. In comparison, U.S. Pat. No. 6,249,277 B1 (Finger-mounted Stylus for Computer Touch Screen) and U.S. 2007/0013681 A1 (Ambidextrous Multi-function Finger Adaptor) address operational efficiency issues of the user. U.S. 2006/0001646 A1 (Finger Worn & Operated Input Device) sets forth an electrically active finger adjustable device that addresses ergonomic issues arising from repeated use of computer mouses and trackballs. A variation within this category arises with the dual function writing pen and screen stylus described in U.S. Pat. No. 6,527,464 B2 (Fingertip Pen/Stylus). Lastly, U.S. 2006/0221066 A1 (Touch Screen Data Control Device) and U.S. Pat. No. 7,849,521 B1 (Fingertip Manipulation Device for Use with Gloves & Insertion Device & Method of Insertion) set forth glove mounted or finger mounted touch screen stylus that focus on operational efficiency, productivity or ergonomic issues. Notably, by descriptions of their construction none of these inventions appears to interact directly or incidentally with capacitive touch screen displays.

A variation of this second major category gives special attention to small mechanical keyboards. U.S. 2009/0266626 A1 (Flexible Stylus Tip with Flat Contact Surface) and U.S. 2009/0289893 A1 (Finger Appliance for Data Entry in Electronic Devices) set forth contact surfaces that are designed specifically for mechanical keys. Although these two patents must be considered with respect to the second embodiment of the present invention, they describe contact tips and applications that are substantially different from that set forth herein.

Categories three, four and five pertain more directly to user interaction with capacitive touch screens. The third category pertains to electrically active (i.e., energized) pen-like styluses. U.S. 2010/0053113 (Electromagnetic Stylus for Operating a Capacitive Touch Panel), U.S. 2010/0053120 A1 (Touchscreen Stylus), U.S. 2010/0066693 A1 (Touch Panel Device), U.S. 2010/0170726 A1 (Electronic Stylus, Capacitive Touch Module & Apparatus for Touch Input) and U.S. 2009/0260900 A1 (Untethered Electrostatic Pen/Stylus for Use with Capacitive Touch Sensor) represent the prior art found for this category. As electrically active pen-like styluses, they do not compare in design or operation with the electrically passive yet highly conductive thumb or finger device set forth in the present invention.

The fourth category of prior art pertains to electrically passive pen-like styluses that enable interaction with capacitive touch screen displays. U.S. 2009/0211821 A1 (Capacitive Stylus Pen) & U.S. 2010/0006350 A1 (Stylus Adapted for Low Resolution Touch Sensor Displays) fall into this grouping. These patents set forth conductive disks or plates that are sized so as to activate capacitive touch displays. The second of these two patents also sets forth a separate, electrically active embodiment. Other patents relevant to this category describe technologies that are not electrically energized but which activate capacitive touch screens through magnetic, inductance or piezo-electric means. These are: U.S. 2009/0167727 A1 (Stylus and Electronic Device), which sets forth a magnetic stylus, U.S. 2010/0053120 A1 (Inductance Stylus for Capacitive Touch Screens), which illustrates an inductance design, U.S. 2009/0256824 A1 (Pointer Device for Capacitive Sensitive Touch Screens), which includes a piezo-electric element, and U.S. 2009/0262637 A1 (Passive Stylus for Capacitive Sensors) which sets forth a unique contact surface. All of these pen-like styluses attempt to address the electrical conductivity requirement for interacting with capacitive touch displays without active electrical components. It should be noted that the last invention mentioned above, U.S. 2009/0262637 A1, addresses other performance parameters (see paragraph (0013)) of capacitive touch displays. The design of that invention, however, is substantially different and much more limited in addressing operational parameters of capacitive touch screens when compared to the present invention.

The “Finger Tip Stylus” set forth in patent U.S. 2009/0078478 A1 purports to be usable with a wide range of handheld devices including the Apple iPhone series, which employs capacitive touch displays. In so doing, it falls into this fourth category. That finger tip stylus is largely limited to use with non-capacitive sensor technologies. A variation of its design “contemplates” a copper wire with grounding point to allow compatibility with the Apple iPhone and other devices with capacitive touch displays. Notably, the brief electrically conductive design description given for the “Finger Tip Stylus” is dramatically different from the present invention.

The fifth & final category, finger or thumb passive styluses for interaction with capacitive touch screen displays, sets forth prior art that approach the present invention. U.S. 2009/0278818 A1 (Thumb Worn Tap Devices & Storage Holders for Use with Handheld Electronics) advances the art by describing a device that includes an electrically passive yet conductive tip that enables interaction with capacitive touch screens. It should be noted that said invention also mentions the angular orientations of a “nib” with respect to the longitudinal axis of a user's thumb and separately, to the longitudinal axis of the base of the invention. The design of this thumb worn device, however, is dramatically different from that of the present invention. It should be noted that the “Thumb Worn Tap Device . . . ” does not address the four operational requirements for efficient interaction with capacitive touch displays. U.S. 2005/0231471 A1 (Hand Covering Features for Manipulation of Small Devices) enables cold weather operation of mobile devices with gloves or mittens by including at least one conductive tip in its embodiments. This design too is dramatically different from that in the present invention.

### BACKGROUND OF THE INVENTION

Numerous models of smartphones & other handheld devices have become widely available over the last several years. These devices come in multiple forms with the two most popular being 1.) those that offer full capacitive touch screen displays with soft on-screen keyboards, and 2.) those that combine small mechanical keyboards with full or partial displays. These full or partial displays can deploy a range of screen technologies including capacitive touch, resistive touch, pressure sensitive and non-touch sensitive. The computational capabilities of these devices continue to increase rapidly while their physical sizes remain small or even continue to decrease in size. The user's ability to interface with these ever smaller devices becomes more & more difficult especially when entering text messages, instant messages and e-mails or inputting data on the small keyboards.

Capacitive touch displays have been selected by manufacturers of smartphones and other handheld devices for a number of reasons: they are easily activated by the human thumb or finger, enable multiple concurrent touches and provide high transparency, among other reasons. A simple light touch with a finger or thumb will successfully activate a capacitive touch screen display. Overall, the human thumb or finger is very suitable for interacting with capacitive touch screens since it satisfies four key operating parameters required for effective & efficient interaction with that screen technology. These are: 1.) electrical conductivity, 2.) a minimum-sized contact area, 3.) proper durometer (measure of hardness) of the contact point, and 4.) a low coefficient of friction that enables easy on-screen scrolling. The human thumb or finger, however, often times, provides too large a contact area for accurate & efficient interaction with the small keyboards on smartphones & other handheld devices. Further, the human thumb or finger, when engaging a flat capacitive touch display, does not provide tactile feedback to a user. In contrast, a user experiences considerable tactile feedback when pressing mechanical keys on handheld calculators and similar devices. Tactile feedback is important to user satisfaction; it gives confidence to the user of small capacitive touch displays that a single key has been successfully engaged.

Devices or inventions that intend to replace or otherwise improve upon thumb or finger interaction with capacitive touch displays must be electrically conductive from the user to the display as a necessary condition for capacitive touch screen activation. This condition makes obvious that conductive materials such as metals, metal infused fabrics, and other electrically conductive materials must be employed in any small finger stylus or pen-like device designed to work with capacitive touch displays. Our search of the prior art reviewed and evaluated the claims of the full range of thumb or finger styluses and pen-like styluses and, in turn, focused on those that provide passive electrical conductivity for interaction with capacitive touch screens.

The inventions found in our search of the prior art offer a wide range of designs. In all cases, the relevant inventions differ substantially in design to the present invention. The prior art also fails to address all four operating parameters (described in paragraph (0013)) for optimizing interaction with capacitive touch displays. A majority of the relevant prior art focuses on the electrical conductivity requirement of capacitive touch displays. This requirement is certainly necessary but not sufficient to fully optimize thumb & finger interaction with capacitive touch displays on smartphones & other handheld devices.

### SUMMARY OF THE INVENTION

The present invention relates to the general field of thumb & finger styluses and pen-like pointing devices used to activate & interact with capacitive touch screens such as those found in smartphones. The instant invention sets forth a pair of passive (not containing electrically active or energized components) thumb or finger styluses that are highly electrically conductive and designed in such a way as to maintain an uninterrupted conductive path from the user's thumb or finger, through the present invention and to the capacitive touch screen. This, in turn, allows easy & reliable activation & operation of capacitive touch displays.

Besides addressing the electrical conductivity requirement, the present invention addresses the remaining operating parameters that enable highly accurate, fast & reliable character selection for text messages, instant messages, e-mails and other data on capacitive touch screen displays. In turn, it improves the overall user experience with smartphones & other handheld devices. These additional operating parameters are: the minimum size of the contact area (but not of an excessively broad or ambiguous size), the durometer of the contact tip, and the tip's coefficient of friction. Notably, the present invention also addresses the user convenience factor of tactile feedback. Taken together, this invention presents a robust solution that enables accurate character selection on small capacitive touch screens. The present invention when used in pairs not only improves accurate & reliable character selection but also dramatically improves the speed at which a user can input characters or data on small devices with capacitive touch screens or mechanical keyboards. Overall, the present invention improves upon the user experience with smartphones and other handheld devices that employ small capacitive touch displays. Note: through adjustments to the individual design parameters, this invention is optimized for two distinct embodiments as mentioned in the next two paragraphs.

In the first embodiment, the present invention sets forth design parameters that are optimized for those smartphones and other handheld devices that employ full screen capacitive touch displays.

In a second embodiment, the present invention sets forth different values for the design parameters that enable optimal interaction with those smartphones and handheld devices that combine small mechanical keyboards with a wide range of touch display technologies. These technologies can include capacitive touch screens, resistive touch displays and pressure sensitive displays. In this second embodiment, the values of the design parameters are optimized first for physical movement of the small mechanical keys and second, for interaction with a range of touch display technologies.

### BRIEF DESCRIPTION OF THE DRAWINGS

FIG. 1A illustrates an exemplary pair of thumb sleeves of the present invention interacting with a representative smartphone with a full capacitive touch screen display (the first embodiment).

FIG. 1B is a side section elevation view that shows the placement of the present invention on a person's finger and further shows the approximate angular orientation of the flexible conductive tip as it comes into contact with a capacitive touch screen (the first embodiment).

FIG. 1C illustrates the softness (low durometer) of the flexible conductive tip as it activates a representative capacitive touch display (the first embodiment).

FIG. 2A offers a side section detailed view of the flexible tip (the first embodiment) illustrating the dimensions of the flexible tip and the approximate placement of the wrap-around conductive fabric as it forms an electrically conductive contact pad on the backside of the flexible tip.

FIG. 2B is a side section elevation of the overall thumb or finger sleeve including placement of the flexible tip.

FIG. 2C illustrates a front-facing longitudinal view of the flexible tip (the first embodiment) covered with a highly conductive fabric that wraps to the backside of the tip where it forms a conductive contact pad. This image illustrates the fabric contact pad before placement of an electrically conductive metal strip.

FIG. 3A graphically describes the roll, yaw & pitch angles required for proper placement of the conductive flexible tip with respect to the longitudinal, vertical & transverse axes of the thumb or finger sleeves.

FIG. 3B presents a bottoms-up perspective that illustrates the optimal yaw angle of the conductive tip with respect to the longitudinal axis of the thumb or finger sleeve. This yawl angle arises as the user's thumb or finger rotates around the vertical axis.

FIG. 3C illustrates the pitch angle of the flexible tip with respect to the transverse axis of the thumb or finger sleeve.

FIG. 4 illustrates the overall assembly of the present invention.

FIG. 5A applies to the second embodiment. FIG. 5A illustrates a single thumb sleeve of the present invention with modified conductive tip engaging a small mechanical keyboard on a representative smartphone.

FIG. 5B illustrates the differences between the flexible tip for the first embodiment and the modified flexible tip for the second embodiment of the present invention.

FIG. 5C illustrates the wall thickness, length and diameter of the modified flexible tip as employed in the second embodiment. Note: FIGS. 2, 3 and 4 apply equally to the second embodiment when the modified flexible tip (as illustrated in FIG. 5C for the second embodiment) replaces the flexible tip (the first embodiment) in these figures.

### DETAILED DESCRIPTION OF THE PREFERRED EMBODIMENTS

The following descriptions of preferred embodiments make reference to the relevant accompanying drawings that illustrate the specific use scenarios for which the invention can be applied. It is to be understood that other embodiments can be used and structural changes can be made without departing from the scope of the embodiments described in this invention.

As used herein, the terms “capacitive touch screen” and/or “capacitive touch display” refer to capacitance sensor touch technology as employed on smartphones and other handheld mobile devices. In the first embodiment set forth herein, the present invention applies to its use exclusively with capacitive touch screens.

As used herein, the term “mechanical keyboard” refers to the small fixed mechanical keyboards or those physical keyboards that are placed below partial screens, slide out from behind or flip up on selected smartphones. In the second embodiment set forth herein, the present invention applies to and enables the physical movement of individual mechanical keys while also enabling activation of a range of touch screen technologies.

Although the present invention sets forth and illustrates embodiments of thumb and/or finger styluses as they activate & engage capacitive touch displays and/or mechanical keyboards, it should be understood that the embodiments of this invention are not so limited, but are applicable to any thumb or finger stylus-like device. These embodiments apply whether the thumb or finger sleeves are employed singly or in pairs.

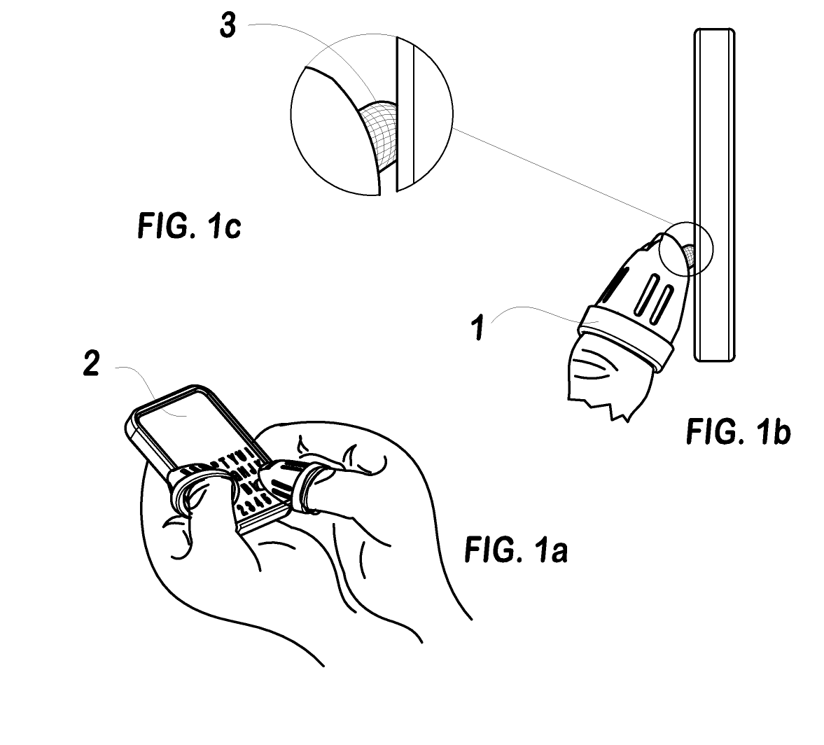

FIG 1A illustrates the first embodiment as it depicts a pair of thumb sleeves 1 comprised of a strong elastic supportive material such as GLS plastic, neoprene laminated with spandex nylon or other strong elastic material or fabric interacting with a full capacitive touch display 2 on a representative smartphone. In this first embodiment, this thumb and/or finger stylus invention is used to easily select and activate characters on small capacitive touch screens as employed on many smartphones. Note: the thumb or finger sleeve 1 may include air vents and a top opening to accommodate a user's thumb or finger nail.

FIG. 1B illustrates a side section elevation of the present invention in this first embodiment as it is employed as a single thumb sleeve 1 supporting flexible tip 3.

FIG. 1C depicts an expanded view of the thumb or finger stylus as shown in FIG. 1B. FIG. 1C illustrates the soft flexible tip 3 making contact with a capacitive touch screen.

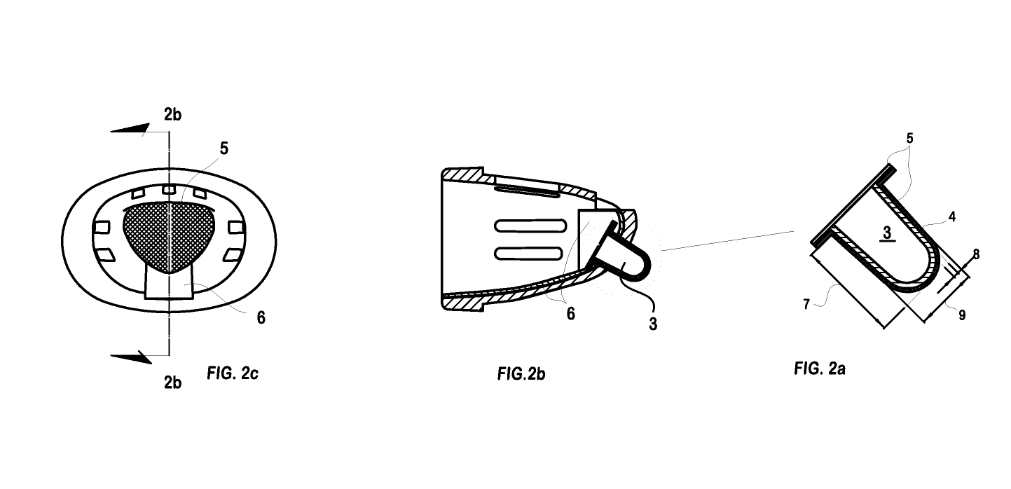

FIG. 2A illustrates a side section view of flexible tip 3 that is covered and wrapped by electrically conductive fabric 4 which, in turn, forms a conductive contact pad 5 on the backside of the flexible tip 3. In this first embodiment, flexible tip 3 has a preferred length 7, a preferred wall thickness 8, and a preferred tip outside diameter 9. When taken together, these dimensions result in a preferred durometer and a sufficiently, but not excessively, broad contact area to activate the capacitive touch screen. In this way, flexible tip 3 mimics the approximate durometer of the user's thumb or finger. Very importantly, the flexible tip 3 when covered with conductive fabric 4 provides a preferred low coefficient of friction that enables the present invention to easily slide across the capacitive touch screen and, in turn, conveniently perform on-screen scrolling. This scrolling operation closely approximates that same operation performed with a human thumb or finger.

In the first embodiment as illustrated in FIG. 2A, the preferred wall thickness 8 of flexible tip 3 provides tactile feedback to a user when the flexible tip 3 engages a capacitive touch display. This tactile feedback indicates to the user that the touch screen has been successfully contacted by the present invention. Notably, the tactile feedback designed into the present invention expands the application of this invention to computer tablets such as the iPad series and other tablets with capacitive touch screens.

FIG. 2B presents a side section elevation of the first embodiment of the assembled thumb or finger sleeve. It illustrates the overall structure of the flexible tip 3, wrapped in conductive fabric 4, which, in turn, forms a contact pad 5 that comes into direct contact with an electrically conductive metal strip 6. FIG. 2B further illustrates the placement of the flexible tip assembly, which is comprised of flexible tip 3, conductive fabric 4, fabric contact pad 5 & conductive metal strip 6 within the supporting thumb or finger sleeve 1.

FIG. 2C illustrates a front-facing longitudinal view of the thumb or finger sleeve with flexible tip 3 wrapped with conductive fabric 4. It can be seen that the conductive fabric 4 not only covers the point of the flexible tip 3 but also wraps around to the backside of flexible tip 3 where it forms a contact area 5. This contact pad 5 provides an engagement point for the conductive metal strip 6 that, in turn, meets the user's thumb or finger. When a user's thumb or finger touches the conductive metal strip 6 it completes the electrical circuit from the user's finger, through the conductive fabric 4, and to the capacitive touch display. In this way, the present invention sets forth a highly reliable electrically conductive path from the user to the capacitive touch display. Note: the conductive fabric 4 has a preferred fabric composition with low electrical resistance that, in turn, results in a preferred high level of electrical conductivity from the user's thumb or finger to the capacitive touch display.

The present invention described in the above paragraph is substantially different and simpler in design from that expressed in U.S. 2009/0262637 A1 (Passive Stylus for Capacitance Sensor). That patent sets forth a pen-like stylus shaft, multiple layers of conductive components, multiple materials, gaseous materials and a conductive pen-like shaft. Further, that invention, U.S. 2009/0262637 A1, sets forth an internal support region as well as a pen-like stylus to give structure to its flexible tip. In contrast, the present invention sets forth an external support structure, namely the external thumb or finger sleeve 1 for the flexible tip 3.

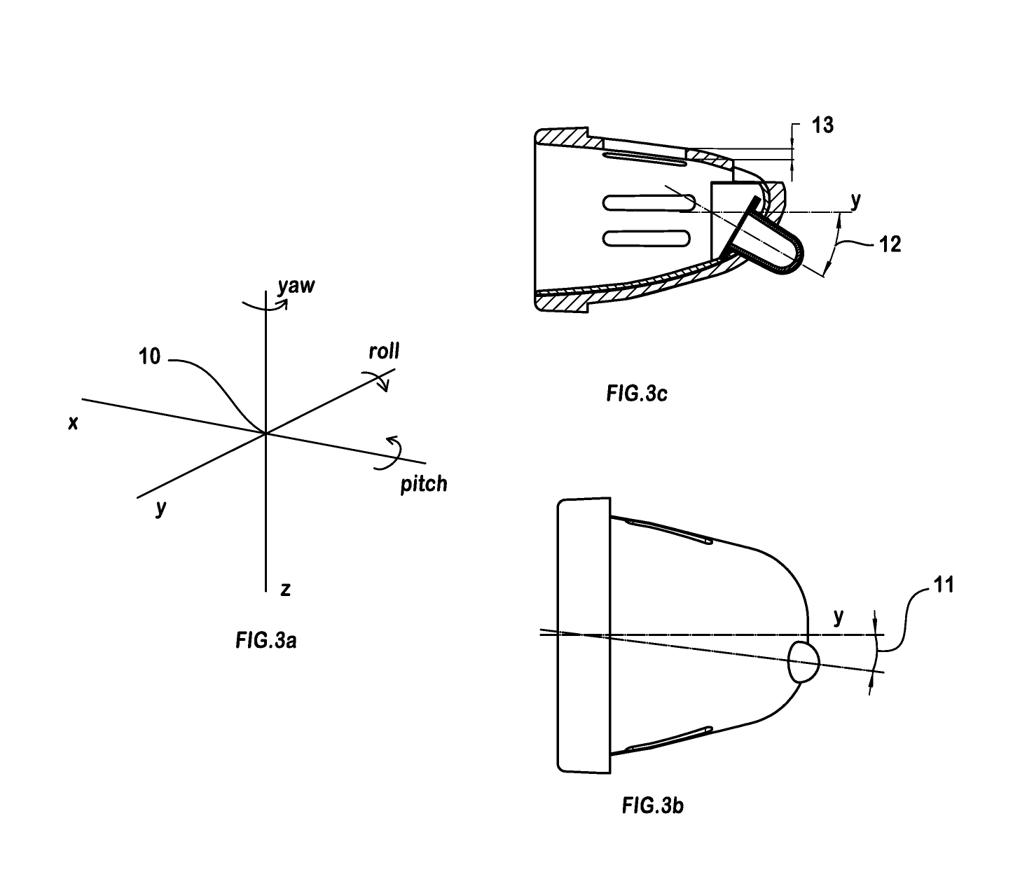

FIG. 3A graphically illustrates the roll angle 10 which depicts the angular roll of the thumb or finger as it engages with the narrow vertical or the wider horizontal plane of smartphones and other handheld devices. The roll angle 10 gives the user of smartphones and other handheld devices the ability to grasp these devices with one or both hands and, at the same time, comfortably enter text or data. The roll angle 10 is an important angular alignment parameter for a thumb or finger sleeve to effectively engage a capacitive touch display. This roll angle 10 when combined with yaw angle 11 (discussed in the next paragraph) drives the angular measure of the pitch angle 12.

FIG. 3B illustrates yaw angle 11. Yaw angle 11 enables a user to comfortably engage with a smartphone or other handheld device by accommodating the movement of a user's thumb or finger around the vertical axis. This angular parameter is essential in allowing the user to address the touch screen with the thumb or finger originating from sides of the capacitive touch screen or mechanical keyboard. Notably, reversing the right or left thumb or finger sleeve to the opposite digit will compensate for the changes in the roll angle 10 & yaw angle 11 of a user's thumbs or fingers when a user changes the position of a smartphone from the vertical to landscape (i.e., horizontal) orientation and vice versa.

FIG. 3C illustrates an approximate pitch angle 12 of the flexible tip 3 as measured from the longitudinal axis of the thumb or finger sleeve 1. This pitch angle 12 is a function of the preferred roll angle 10 and the preferred yaw angle 11 described in the two preceding paragraphs. Note: U.S. 2009/0278818 A1 (Thumb Worn Tap Devices and Storage Holders for use with Handheld Electronics) describes an angle alpha (from the base of the device to a nib) and a second angle beta (from the longitudinal axis of the user's thumb or finger to the nib). Those two angles (alpha & beta) recognize only one axial plain. In contrast, the present invention's downward pitch angle 12 is a function of both the roll angle 10 and the yawl angle 11. Taken together, roll angle 10, yawl angle 11 and pitch angle 12 accommodate the use of smartphones and other handheld devices in both vertical- and horizontal-plane orientations.

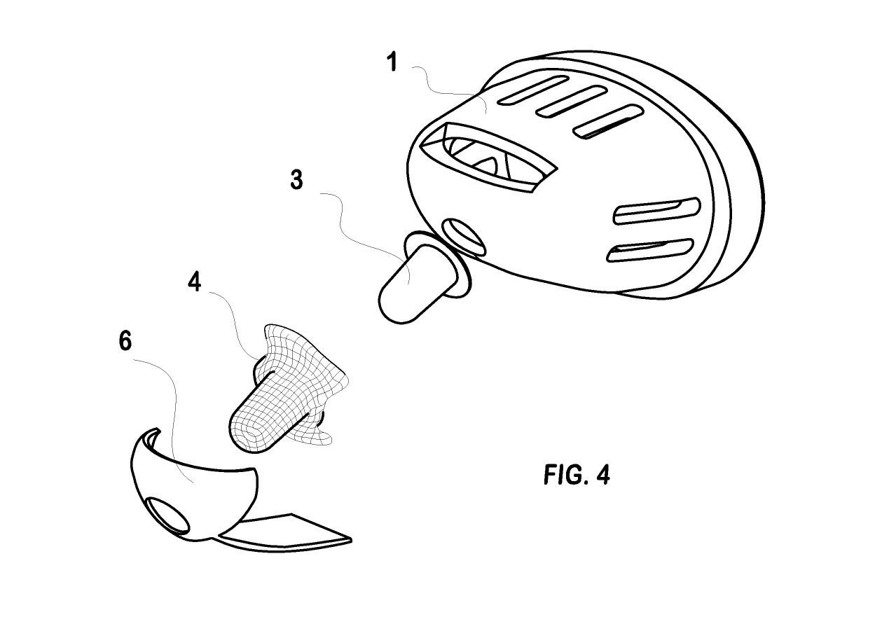

FIG. 4 provides an overview of the components that comprise the thumb and/or finger sleeves that define both the first and second embodiments. This figure illustrates a single thumb or finger sleeve 1, flexible tip 3, wrapped with conductive fabric 4, which forms contact pad 5, which meets the conductive metal strip 6, which, in turn, forms the contact surface for engagement with the user's thumb or finger. Note: thumb or finger sleeve 1 can be comprised of injection molded materials, neoprene, spandex and/or other elastic material or fabric of preferred thickness or gauge 13 so as to provide a relatively flexible yet sufficiently strong & supportive vehicle for the flexible tip 3. Importantly, the composition and preferred thickness 13 of the thumb or finger sleeve 1 provide comfort for the user while, at the same time, securely fixing the flexible tip 3 in a constant position with respect to the user's thumb or finger.

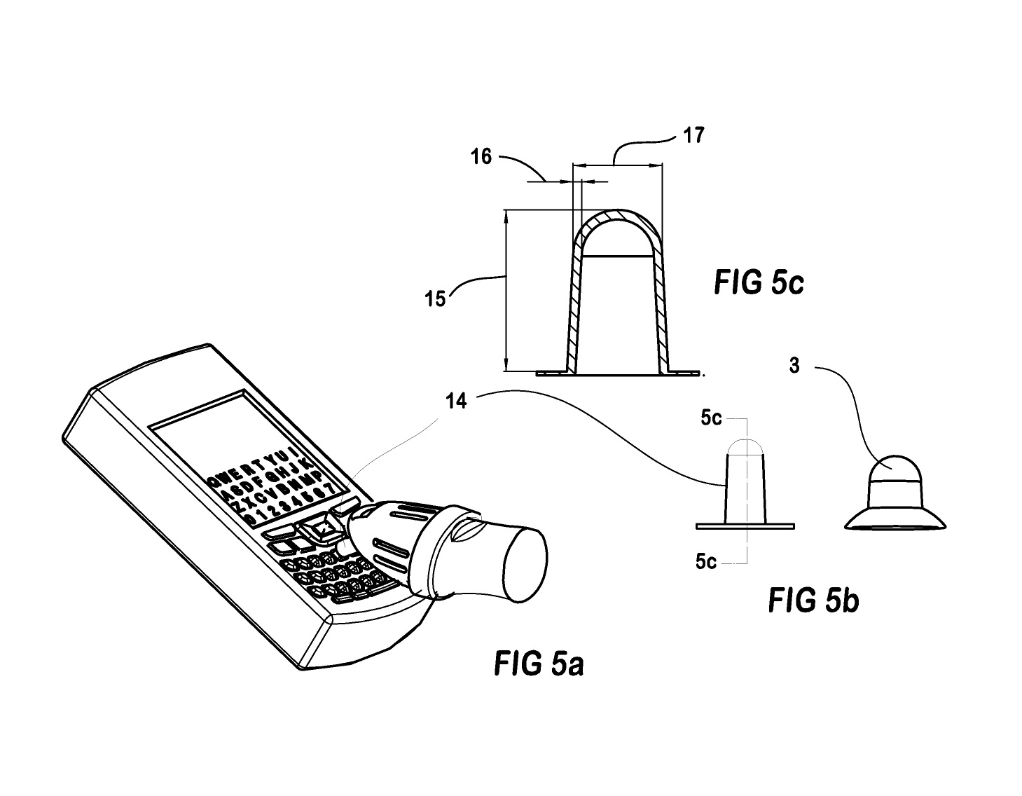

In the second embodiment, the present invention pertains to use with those smartphones or other handheld devices that employ small mechanical keyboards along with full or partial displays. FIG. 5A illustrates this second embodiment. For this second embodiment, the design parameters of the present invention are optimized first for the engagement of the small mechanical keys and second, for activation of capacitive touch screens and other touch screen technologies.

FIG. 5B illustrates that there are clear differences in the dimensions of the flexible tips as they are designed for the first and second embodiments of this invention. For the second embodiment, the modified flexible tip 14 comes with preferred dimensions of length 15, wall thickness 16, and outside diameter 17. Those tip dimensions, which define the durometer of the modified flexible tip 14, are optimized for operating small mechanical keyboards that call for physical movement of the small keys. Notably, the preferred dimensions for the modified flexible tip 14 deployed in the second embodiment are substantially different from the preferred dimensions for flexible tip 3 deployed in the first embodiment.

FIG. 5C expands the view of the modified flexible tip 14, which applies to the second embodiment. In this embodiment, the modified flexible tip 14 comprises a preferred longer length 15, preferred greater wall thickness 16, and preferred narrower diameter 17. Taken together, these dimensions result in a smaller contact point with a higher preferred durometer than those factors described in the first embodiment. This higher durometer enables this second embodiment to engage not only mechanical keys but also pressure sensitive displays. In this second embodiment, this modified flexible tip 14 enables greater precision in the selection of small mechanical keys and, in turn, is better able to physically engage & move the mechanical keys without excessive tip compression. Most importantly, in this second embodiment, the use of the same conductive fabric 4 described in the first embodiment and the modified flexible tip 14 with its attendant higher durometer enable effective interaction with capacitive touch displays as well as pressure sensitive displays or other touch screen technologies that may accompany small mechanical keyboards on smartphones and other handheld devices. Note: FIGS. 2, 3 and 4 pertain directly to this second embodiment when modified flexible tip 14 replaces flexible tip 3 in these figures.

It is to be understood that the present invention is not limited to the embodiments described herein. The foregoing descriptions, design features, preferred embodiments, operating parameters, methods of operation and related information should be regarded as illustrative and not restrictive in any way. The different features, including fit, form, function, materials and/or design parameters of the embodiments described herein, can be combined in ways other than those explicitly described herein and still be within the scope of the present invention as defined by the claims listed below.

1-13. (canceled)

14: I claim the design of a thumb or finger mounted device that includes a thumb or finger sleeve and a flexible tip that is firmly attached to each sleeve. Each tip is covered with an electrically conductive fabric, which, in turn, wraps to the backside of the flexible tip to form an electrically conductive contact pad. This contact pad touches a conductive metal strip or tab which, in turn, comes into direct contact with a user's thumb or finger. This device can be used singly or in pairs.

15. I claim the design of thumb or finger sleeves, comprised of flexible elastic materials such as injection molded thermoplastics, nylon laminated neoprene or similar materials, which provide for fixed placement of the sleeves on the user's thumbs or fingers. The thumb or finger sleeves serve as the vehicles and stable platforms for the electrically conductive tips which, in turn, provide uninterrupted electrical contact between a user's thumb or finger and a capacitive touch screen.

16: I claim the design of flexible tips made of polyurethane or similar compound with individually preferred lengths, wall thicknesses, and outside diameters for the two separate embodiments described herein. These preferred lengths, wall thicknesses and diameters provide the preferred minimum contact areas and the preferred durometers for the two individual embodiments, which enable accurate character selection on smartphones or other handheld devices with full capacitive touch displays and on small mechanical keyboards combined with other touch screen technologies, respectively.

17: I claim the placement of the electrically conductive tips at a preferred off-axis location on the thumb or finger sleeves to accommodate the angular orientation of a user's thumbs or fingers when engaging capacitive touch screens on smartphones or small mechanical keyboards. The preferred location of the flexible tips with respect to the peak of the thumb or finger sleeves allows the user to operate the touch screens or mechanical keyboards in either the vertical or landscape (i.e., horizontal) orientations.

18: As to the design of the thumb or finger sleeves of claim 15, I further claim the design of a lateral slot or opening that accommodates a user's thumb nail or finger nail. Such slot further contributes to the fixed placement of the thumb or finger sleeves while a user engages a small capacitive touch screen or small mechanical keyboard.

19: As to the first embodiment of claim 16, I claim the durometer, wall thickness and length of the flexible tips are designed as to cause tactile feedback from the flexing & responsiveness of the conductive flexible tip as it engages the capacitive touch screen. This flexing of the tip provides the required minimum contact area necessary for activation of capacitive touch screens.

20: As to the second embodiment of claim 16, I claim the durometer, wall thickness and length of the flexible tips are designed as to cause simple movement of the small mechanical keys found on those smartphones that combine small mechanical keyboards with various touch display technologies. Notably, tactile feedback in this second embodiment comes from movement of the mechanical keys and not from the flexibility & responsiveness of the flexible tips.

21: With respect to claim 17, I claim roll angles of preferred angular measures (as they apply to all embodiments of the present invention), formed between the flexible tips and the longitudinal axis of the user's thumbs or fingers, enable the user to comfortably & efficiently engage with smartphones or other handheld devices as the user's thumbs or fingers roll inside or outside to activate the small capacitive touch screens or small mechanical keyboards. By placing the right & left thumb or finger sleeves on the opposite digits, left & right, respectively, the roll angle provides the user a level of personal adjustment & customization in the use of the present invention when shifting from vertical to landscape or to the reverse orientations or when accommodating individual comfort preferences.

22: With respect to claim 17, I claim yaw angles of preferred angular measure (as they apply to all embodiments of the present invention), formed between the flexible tips and the vertical axis of the thumbs or fingers, enable a user of smartphones and other handheld devices to efficiently & comfortably adapt to the widths of various smartphones & other handheld devices. The yaw angles enable the user to engage the capacitive touch screens or mechanical keyboards comfortably as the individual users orient their thumbs or fingers at different horizontal approach angles.

23: With respect to claim 17, I claim pitch angles of preferred angular measure for the electrically conductive tips relative to the longitudinal axis of the user's thumb or finger tips are functions of the preferred roll & yawl angles and serve to compensate for the user's thumbs or fingers vertical orientations to the touch screens or small mechanical keyboards.
